(19) United States
(12) Patent Application Publication
(10) Pub. No.: US 2026/0222187 A1
(43) Pub. Date: Jul. 30, 2026

(54) Control Device For Communication Network

(71) Applicants: National Institute Of Information And Communications Technology, Tokyo (JP); Siglead Inc., Kanagawa (JP)

(72) Inventors: Masahide Sasaki, Tokyo (JP); Mikio Fujiwara, Tokyo (JP); Atsushi Esumi, Kanagawa (JP); Kai Li, Kanagawa (JP)

(73) Assignees: National Institute Of Information And Communications Technology, Tokyo (JP); Siglead Inc., Kanagawa (JP)

(21) Appl. No.: 19/145,276

(22) PCT Filed: Nov. 15, 2023
(86) PCT No.: PCT/JP2023/041058

§ 371 Date: Jul. 2, 2025

(30) Foreign Application Priority Data
Jan. 11, 2023 (JP) 2023-002540

(51) Int. Cl. H04L 9/08; H04L 1/00; H04L 9/12; H04L 12/22

(52) U.S. Cl. CPC H04L 9/0855; H04L 1/004; H04L 9/12; H04L 12/22

(57) ABSTRACT

The disclosed systems and methods assist transmitted content in reaching a receiver, even if a network is subjected to sophisticated tampering. A device for a communication network including a plurality of nodes and a plurality of paths connecting a source node, which is a transmission source of information, and a terminal node, which is a destination of the information. A segmentation instruction unit being configured to instruct the source node to disperse the information into a plurality of pieces of random number data, to encode the random number data by an error correction code to generate codewords, and to order the codewords from the beginning and divide the codewords into a plurality of segments, the first transmission instruction unit being configured to instruct the source node to transmit OTP-encrypted data of the plurality of segments through the plurality of paths.

### TECHNICAL FIELD

The present invention relates to control devices for communication networks.

### BACKGROUND ART

Technologies for sharing an encryption key between two locations include mathematical cryptographic technologies based on assumptions of computational complexity and computational-theoretic security, and cryptographic technologies utilizing physical phenomena based on the laws of nature. Currently, widely used public key cryptosystems belong to the former technologies, but their security is threatened by improvement in the power of computers used for decryption. On the other hand, quantum key distribution, which has recently attracted attention, belongs to the latter technologies, and the security of a shared encryption key is proven by information theory, independently of the power of computers. Thus, the use of quantum key distribution is expected in fields where advanced security and permanent secrecy are requested.

In quantum key distribution, it is possible to share a secret physically generated random number (physical random number) sequence that is information-theoretically secure by skillfully utilizing the laws of quantum mechanics that special optical signals obey. Thus, a transmitter and a receiver are each provided with a quantum key distribution device for transmitting and receiving the quantum state of light, separately from a classical communication system for transmitting and receiving data. By using the physical random number sequence shared in advance in this manner as an encryption key for encrypting data and a decryption key for decrypting data, it is possible to encrypt a transmission link of data communication connecting the transmitter and the receiver. In this case, as long as a physical random number sequence having the same length as data is used only once (in a one-time pad or OTP), it is impossible for an eavesdropper to break encryption of the transmission link. Thus, the transmitter and the receiver can share any encryption key by transmitting and receiving the encryption key as data by using the encrypted transmission link.

However, a distance over which an encryption key can be shared by the above-described method is limited. This is because a distance over which a physical random number sequence can be shared has a physical limit, and the limit is attributable to loss of an optical signal representing a quantum state as it propagates through an optical fiber. In a case of communication wavelength bands, the limitation distance is approximately 100 km.

Key relay technology is known as a means of extending the distance between two points between which an encryption key can be shared. As illustrated as a communication network NW1 in FIG. 1, a starting point (source node SN) at which the transmitter is positioned and an end point (terminal node TN) at which the receiver is positioned are connected by one relay path R1 for data transmission through a plurality of reliable relay nodes V11 to V13. The relay path R1 includes four transmission links each connecting two adjacent nodes. Specifically, they are a transmission link connecting the source node SN and the relay node V11, a transmission link connecting the relay node V11 and the relay node V12, a transmission link connecting the relay node V12 and the relay node V13, and a transmission link connecting the relay node V13 and the terminal node TN. The length of each transmission link is a length over which a physical random number sequence can be shared. Key relay is a technology in which an encryption key is relayed and transmitted from the source node SN to the terminal node TN after all transmission links on the relay path R1 are each encrypted by using the above-described physical random number sequence in a one-time pad manner.

In the key relay method, an encryption key is encrypted at the tail node in each encrypted transmission link on a relay path, and the encryption key is decrypted at the head node. This encryption and decryption are repeated for each transmission link to relay and transmit the encryption key from the starting point to the end point.

Such a key relay method using one relay path enables relay transmission of an encryption key over a long distance in a model in which all relay nodes on the relay path are reliable.

Note that a key transmission network for performing relay transmission of an encryption key can be managed and operated separately from a user service network (in other words, a network for transmitting data encrypted by using the encryption key).

Since information of an encryption key that is not encrypted is processed at relay nodes on a relay path, it is assumed that no information leaks from the relay nodes, in other words, the relay nodes are reliable.

However, in the key relay method using one relay path, information of the encryption key is completely decrypted at each arrival at a relay node. Thus, there is a problem in that if even one of the relay nodes on the relay path is under the influence of an eavesdropper (if any one relay node is compromised), the secrecy of the encryption key is broken.

A quantum key distribution system is disclosed in Patent Document 1. The quantum key distribution system includes a plurality of routing devices configured to relay a key, and a quantum key distribution device that is connected to the routing devices and configured to execute corresponding quantum key negotiation with another quantum key distribution device by using two or more different paths to acquire a shared key.

### REFERENCE DOCUMENT LIST

### Patent Document

Patent Document 1: Japanese Translation of PCT International Application Publication No. JP-T-2018-502514

### SUMMARY OF THE INVENTION

### Problem to be Solved by the Invention

With conventional technologies, sophisticated tampering executed by a network attacker cannot be sensed in some cases. This results in a problem in that when information is transmitted from the transmitter to the receiver, information with contents intended by the transmitter does not reach the receiver.

The present invention has been made in view of such a situation and is intended to increase the likelihood that information with contents intended by a transmitter reaches a receiver even if a network is subjected to sophisticated tampering.

### Means for Solving the Problem

To achieve the above-described intention, a control device for a communication network including a plurality of nodes and a link connecting two of the nodes assumes that a plurality of paths connecting a source node, which is a transmission source of information, and a terminal node, which is a destination of the information, through relay nodes are set so as not to share the same relay node, and includes: a segmentation instruction unit configured to instruct the source node to disperse the information into a plurality of pieces of random number data, to encode the random number data by an error correction code to generate codewords, and to order the codewords from the beginning and divide the codewords into a plurality of segments; and a first transmission instruction unit configured to instruct the source node to transmit OTP-encrypted data of the plurality of segments through the plurality of paths.

### Effects of the Invention

According to the present invention, it is possible to increase the likelihood that information with contents intended by a transmitter reaches a receiver even if a network is subjected to sophisticated tampering.

### BRIEF DESCRIPTION OF THE DRAWINGS

FIG. 1 is an explanatory diagram illustrating an example of a communication network.

FIG. 2 is an explanatory diagram illustrating another example of the communication network.

FIG. 3A is an explanatory diagram illustrating a situation in which codewords are divided into a plurality of segments at a source node.

FIG. 3B is an explanatory diagram illustrating a situation in which segments are transferred through relay paths.

FIG. 3C is an explanatory diagram illustrating a situation in which codewords are obtained from a plurality of segments at a terminal node.

FIG. 4 is an explanatory diagram illustrating a case in which a plurality of segments having the same segment index are assigned to the same relay path.

FIG. 5A is an explanatory diagram illustrating a situation in which a failure has occurred to one relay path.

FIG. 5B is an explanatory diagram illustrating a situation in which erasure caused by a failure on a relay path is restored.

FIG. 6 is an explanatory diagram illustrating encoding and segmentation of an encryption key and assignment of segments to paths.

FIG. 7 is an explanatory diagram illustrating a situation in which codewords are obtained from a plurality of segments and a situation in which an encryption key is obtained from a plurality of codewords.

FIG. 8 is a block diagram of a control device for the communication network.

FIG. 9 is an explanatory diagram illustrating an example of a computer hardware configuration of a node.

### MODE FOR CARRYING OUT THE INVENTION

The present invention will be described below based on illustrated embodiments. However, the present invention is not limited by the embodiments described below.

The inventor of the present invention first diligently discussed key relay as described below.

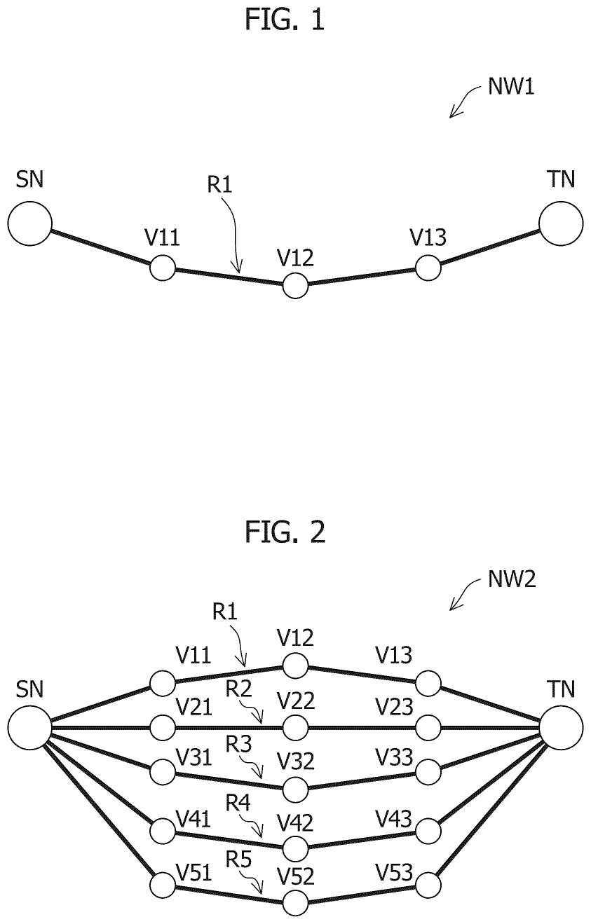

The key relay technology disclosed in Patent Document 1 is basically constituted by three elements described below.
(1) A total of nR (nR is an integer of two or more) relay paths for data transmission are provided between a source node and a terminal node. As an example with nR=5, five relay paths R1 to R5 are provided between a source node SN and a terminal node TN as illustrated as a communication network NW2 in FIG. 2. The relay path R1 is the same as illustrated in FIG. 1. Similarly to the relay path R1, the relay path R2 is provided with three relay nodes V21 to V23, the relay path R3 is provided with three relay nodes V31 to V33, the relay path R4 is provided with three relay nodes V41 to V43, and the relay path R5 is provided with three relay nodes V51 to V53. In this manner, the five relay paths R1 to R5 are provided so as not to share relay nodes.
(2) Transmission links connecting two adjacent nodes on each relay path are individually encrypted by using physical random number sequences shared through quantum key distribution.
(3) A transmitter located at the source node SN generates (n−1) secret random numbers u₂, u₃, . . . , uₙ having the same length as an encryption key S to be sent to a receiver located at the terminal node TN. In addition, encrypted data u₁ is defined such that the exclusive OR of the generated (n−1) random numbers and u₁

$${u}_{1} ⊕ {u}_{2} ⊕ {u}_{3} ⊕ … ⊕ {u}_{n} \qquad [ Formula 1 ]$$

matches the encryption key S. Data uᵢ (i=1 to n) is referred to as random number data. In this manner, information of the encryption key S is secret-shared among n pieces of random number data uᵢ. n is an integer equal to or smaller than nR.

With the above preparation, the source node SN distributes and transmits the n pieces of random number data uᵢ, one on each of n different relay paths. Accordingly, information of the encryption key S is physically secret-shared among the n paths. The terminal node TN receives a total of n pieces of random number data from the n different relay paths. The terminal node TN calculates the exclusive OR of the n pieces of random number data uᵢ

$$S = {u}_{1} ⊕ {u}_{2} ⊕ {u}_{3} ⊕ … ⊕ {u}_{n} \qquad [ Formula 2 ]$$

to restore the encryption key S.

Such key relay as described above is referred to as distributed key relay. In the distributed key relay method, information of the encryption key S is secret-shared among n pieces of random number data, and each piece of random number data has no correlation with the encryption key S. These n pieces of random number data are assigned to different relay paths. Thus, in order to restore the encryption key S, it is needed to collect the n pieces of random number data from the n relay paths. A node capable of executing this alone is limited to the terminal node where the receiver is located.

Thus, even if any relay node is compromised, no information of the encryption key S leaks from a single relay node, and the secrecy of the encryption key is maintained. In this manner, the distributed key relay method using a plurality of relay paths enables relay transmission of the encryption key over a long distance while maintaining secrecy under a model in which path information is kept private and several relay nodes are not simultaneously compromised across all relay paths.

Note that a key transmission network for performing relay transmission of the encryption key can be managed and operated separately from a user service network (in other words, a network for transmitting data encrypted by using the encryption key).

By introducing an error correction code into the distributed key relay as described above, in the same manner as in normal data transmission, it is possible to detect and correct transmission errors occurring in transmission links and signal processing errors occurring in relay nodes. Minor tampering disguised as an error can be detected and corrected within the capacity of the error correction code.

However, as described below, if an attacker executes sophisticated tampering, only introducing an error correction code into the distributed key relay is not sufficient to cope with this. As a result, there is a problem in that an encryption key S′, which is different from the encryption key S and to which errors are intentionally added by the attacker, is restored and used as the encryption key.

Sophisticated tampering is briefly described below. Typically, an error correction code senses deviations from the original codewords, which are caused by errors or tampering, and corrects the deviations by utilizing correlations among a plurality of bits constituting the codewords. Thus, an error correction code is powerless against sophisticated tampering that replaces a codeword with another codeword.

Such tampering can be easily executed not only at relay nodes but also at encrypted transmission links. This is because, when a bit pattern corresponding to the difference between two codewords is added to (subjected to an exclusive OR operation with) a bit sequence obtained by encrypting plaintext to which an error correction code is applied, the decoded plaintext is replaced with the original correct plaintext to which the bit pattern is applied.

If the original plaintext is a meaningful message, such tampering only results in incomprehensive content and could be easily detected. Therefore, in normal message transmission, such tampering as described above has not been considered to be a problem. However, in a case in which the original plaintext is random number data such as the encryption key S, the tampered plaintext is restored as another piece of random number data, which results in a problem in that the tampering cannot be detected. In other words, the integrity of the encryption key S is not guaranteed in the distributed key relay.

In the present specification, “integrity” means that information with contents intended by the transmitter reaches the receiver when the information is transmitted from the transmitter to the receiver.

An embodiment of the present invention will be described below based on discussion of the distributed key relay as described above. According to the embodiment of the present invention, the encryption key intended by the transmitter is restored at the terminal node even if sophisticated tampering by an attacker is executed on a relay path of the distributed key relay.

Specifically, the following three elements are newly introduced into the above-described distributed key relay. The first is introduction of an appropriate error correction code, the second is division of a codeword into a plurality of segments, and the third is transmission of the segments by dividing the segments into a plurality of different relay paths in accordance with a rule. By combining these three elements, it is possible not only to correct errors and simple tampering, but it is also possible to detect and automatically correct sophisticated tampering that cannot be handled by an error correction code alone. Accordingly, not only the secrecy, but also the integrity of the transmitted encryption key S, can be guaranteed.

In order to prevent sophisticated tampering, it is necessary to incorporate in advance a mechanism that makes it impossible for an attacker to replace a codeword. An embodiment described below provides such a mechanism.

Note that a message digest method is typically known as a method of detecting sophisticated tampering, but cannot correct the tampering.

In the embodiment of the present invention, to guarantee the integrity of the encryption key S, one piece of secret-shared random number data uᵢ is converted into a codeword cwᵢ by using an appropriate error correction code. Subsequently, the codeword cwᵢ is divided into a plurality of segments in order from the beginning, and the segments are distributed to different relay paths in accordance with their indices. In this manner, information of a codeword is divided into segments and distributed to a plurality of different relay paths. Thus, an attacker cannot execute sophisticated tampering unless all relay paths are accessed. On the other hand, the receiver can identify an incorrect codeword resulting from relatively minor tampering, and then perform error correction and correctly restore information of the encryption key S.

Moreover, in order to prevent leakage of partial information related to the encryption key S on each relay path, relay paths are allocated so that segments having the same index are not sent on the same relay path when a series of codewords cwᵢ, cwᵢ₊₁, cwᵢ₊₂, . . . is sequentially sent. Accordingly, secrecy is guaranteed as well.

The number of relay paths connecting the source node and the terminal node is assumed to be nR. Note that, for simplification of description, relay paths are assumed not to intersect, bifurcate, nor merge along the way. The number of divisions of segments (n) is assumed to be equal to the number of relay paths (nR).

The source node performs processing below.
1) The encryption key S is expressed by an exclusive OR using (n−1) independent random numbers uᵢ and one piece of encrypted data u₁. n is an integer equal to or less than nR, and i is an integer equal to or greater than two and equal to or less than n. That is, it is as follows.

$${u}_{1} = S ⊕ {u}_{2} ⊕ {u}_{3} ⊕ … ⊕ {u}_{n} S = {u}_{1} ⊕ {u}_{2} ⊕ … ⊕ {u}_{n} \qquad [ Formula 3 ]$$

The encrypted data u₁ and the independent random numbers u₂ to uₙ are referred to as random number data uᵢ to represent them in a unified manner. i is the random number data index, and an integer equal to or greater than one and equal to or less than n. In this manner, information of the encryption key S is dispersed into n pieces of random number data u₁, u₂, . . . , uₙ.
2) The random number data uᵢ is converted into the codeword cwᵢ by using an appropriate error correction code. It is assumed that the size of the random number data fits within the size of the message portion of the codeword.
3) The codeword cwᵢ is divided into nR segments (cwᵢ)ⱼ (j is an integer equal to or greater than one and equal to or less than nR) in order from the beginning. j is referred to as a segment index.
4) In this manner, a total of n×nR segments specified by the random number data index i and the segment index j are prepared.
5) The n×nR segments are assigned to relay paths in accordance with the order of the random number data index i.
6) When each segment is assigned to a relay path in 5) above, the assignment obeys the following rules.
Rule 1: Two segments having the same random number data index i and different segment indices j are assigned to different relay paths.
Rule 2: Two or more segments (cwᵢ)ⱼ and (cw_{i′})ⱼ having different random number data indices i and i′ and the same segment index j are not assigned to the same relay path.

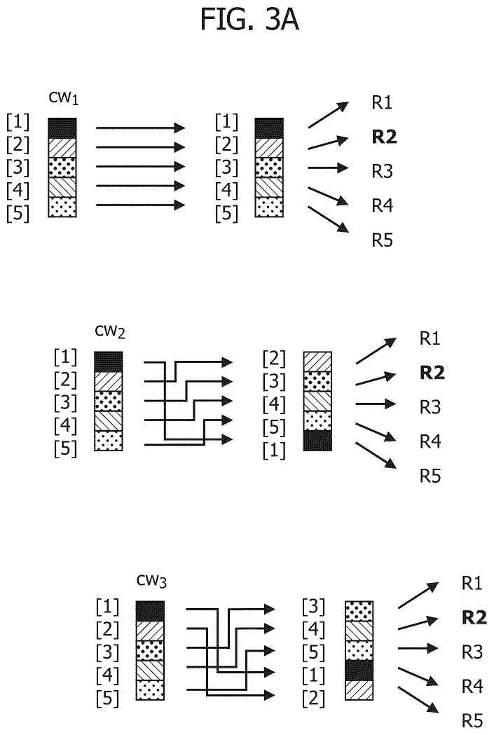

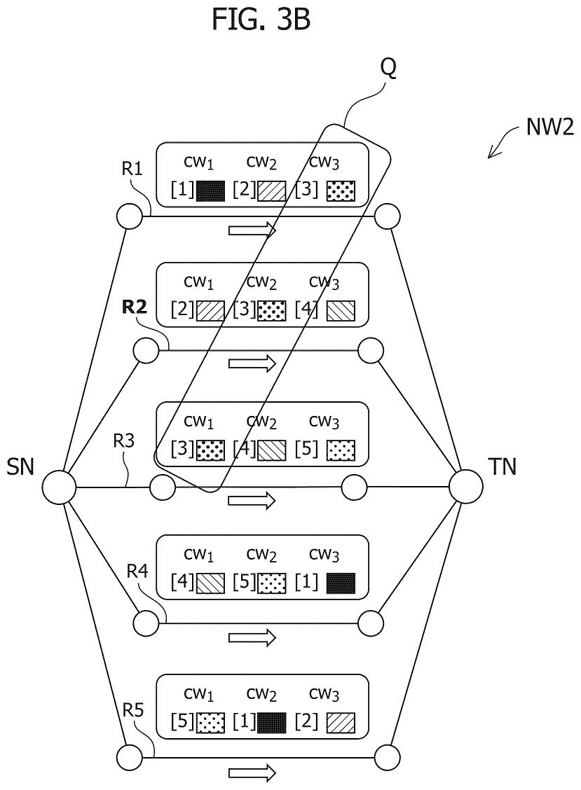

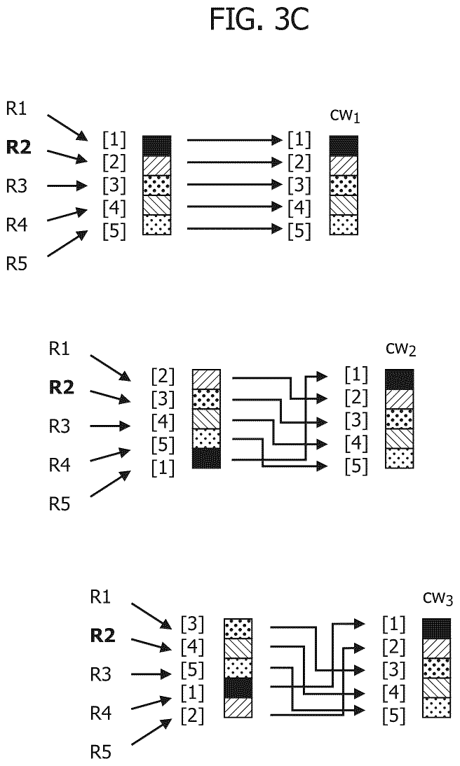

FIGS. 3A to 3C illustrate a specific example. First, the encryption key S is secret-shared among three (in other words, n=3) pieces of random number data uᵢ. This is to guarantee the secrecy of the encryption key S. Subsequently, the codeword cwᵢ for the random number data uᵢ is divided into five (in other words, nR=5) segments (hereinafter, the segment indices j are also expressed as [1], [2], [3], [4], and [5]), and the segments are assigned to any of five different relay paths R1, R2, R3, R4, and R5 for the respective segment indices (FIG. 3A). This is to guarantee the integrity of the encryption key S. In the illustrated example, the order of segments for each codeword is rearranged in accordance with the rules, and then the segments are sent to the relay paths. This is to achieve both the secrecy and the integrity.

Segments having different segment indices [j] are respectively selected from the codewords cw₁, cw₂, and cw₃ corresponding to different pieces of random number data and assigned to one relay path. Through such assignment, it is possible to prevent partial information related to the encryption key S from being accumulated at relay nodes on each relay path. This will be described below.

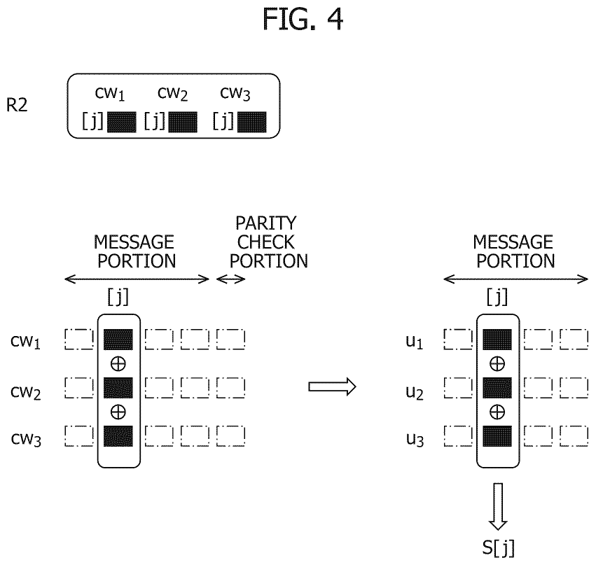

As illustrated in FIG. 4, it is assumed that codeword segments having the same segment index [j] are selected from the codewords cw₁, cw₂, and cw₃ and are assigned to the same relay path R2. It is also assumed that each j-th segment corresponds to a place belonging to the message portion of a codeword. In this case, by attacking a relay node on the path R2, an attacker potentially can acquire all partial random number data u₁[j], u₂[j], and u₃[j] and acquire partial information S[j] related to the encryption key S by calculating their exclusive OR.

As in the example of j=3 illustrated in FIG. 3A, in the present embodiment, in order to prevent leakage of partial information related to the encryption key S, the codeword segments cw₁[j], cw₂[j], and cw₃[j] having the same segment index are assigned to different relay paths to achieve physical secret-sharing. As indicated by reference sign Q in FIG. 3B as an example, the three segments cw₁[3], cw₂[3], and cw₃[3] having the same segment index are assigned to different paths R1 to R3, respectively, and are transmitted.

Processing as below is performed at each transmission link on a relay path.
7) When transferred through a link connecting adjacent nodes on a relay path, each segment (cwᵢ)ⱼ is encrypted (OTP encrypted data) at the tail node based on a one-time pad by a physical random number sequence prepared in advance for the link through quantum key distribution. Subsequently, at the destination node, each segment is decrypted by using the physical random number sequence. In this manner, the above-described encryption and decryption are repeated at each transmission link on a relay path to transmit each segment (cwᵢ)ⱼ from the source node to the terminal node (FIG. 3B).

Processing below is performed at the terminal node. The random number data index i is 1 to n.
8) For any random number data index i, nR codeword segments (cwᵢ)ⱼ (j=1 to nR) transferred through different relay paths are reconstructed in accordance with the order of the segment index j to restore the codeword cwᵢ for the i-th random number data uᵢ (FIG. 3C).
9) In a case in which a pattern that is not a codeword is obtained in 8) above, error correction processing is performed to restore the original codeword. Then, the random number data uᵢ is decoded from the codeword cwᵢ. 10) By using n pieces of random number data u₁, u₂, . . . , uₙ, the exclusive OR

$$S = {u}_{1} ⊕ {u}_{2} ⊕ {u}_{3} ⊕ … ⊕ {u}_{n} \qquad [ Formula 4 ]$$

is calculated to restore the encryption key S.

Effects of the above-described embodiment will be described below.
1) Information of the encryption key S does not leak at a relay node on a single relay path (guarantee of secrecy).

This is achieved as follows. The encryption key S is randomly secret-shared among n pieces of random number data and arrayed along a time axis. Then, each piece of random number data is divided into a plurality of segments in order from the beginning. The segments are assigned to different relay paths, respectively. In this case, a plurality of segments obtained from different pieces of random number data and having the same segment index are transferred through different relay paths.
2) Since a transmission link between two adjacent nodes on a relay path is encrypted by a physical random number sequence shared through quantum key distribution, information related to random number data does not leak from the transmission link (guarantee of secrecy).
3) Even if a transmission error has occurred on a relay path, the correct encryption key S can be restored at the terminal node. In particular, even if the segment (cwᵢ)ⱼ is intentionally tampered with at a relay node, the tampering can be detected and corrected at the terminal node to restore the correct encryption key S (guarantee of integrity).

Guarantee of integrity will be described in detail below.

It is assumed that intentional segment replacement by an attacker, in other words, replacement of the original codeword segment (cwᵢ)ⱼ with a dummy segment (cwᵢ)ⱼ^{#} is performed at a relay node on the relay path R1. In this case, dummy codewords cwᵢ^{#}=(cwᵢ)₁, (cwᵢ)₂, . . . , (cwᵢ)ⱼ^{#}, . . . (cwᵢ)_{nR} are reconstructed at the terminal node. However, the dummy codeword cwᵢ #reconstructed in this manner typically has incorrect patterns differing greatly from the original codewords.

This is explained as follows. First, in a case in which the original segment (cwᵢ)ⱼ is replaced with a dummy segment (cwᵢ)ⱼ^{#}, not only (cwᵢ)ⱼ^{#} but also a segment (cwᵢ)ₖ (k≠j) including the parity check portion (FIG. 4) needs to be correctly changed to maintain consistency so that a codeword reconstructed at the terminal node matches the original codeword. Furthermore, in order to perform the change, information of all other codeword segments is needed as well. However, since the other codeword segments including the parity check portion are transmitted on other relay paths R2, R3, . . . , the attacker cannot manipulate or access them. Thus, for an attacker who can access the one relay path R1, it is impossible to conveniently replace the codeword cwᵢ with another codeword so that some dummy random number data uᵢ^{#} (≠u₁) are decoded at the terminal node.

If an incorrect pattern cwᵢ^{#} is detected at the terminal node, the original codeword cwᵢ is recovered from cwᵢ^{#} by the above-described error correction processing. As a result, the correct random number data uᵢ is decoded, and finally, the encryption key

$$S = {u}_{1} ⊕ {u}_{2} ⊕ … ⊕ {u}_{n} \qquad [ Formula 5 ]$$

is correctly restored. In this manner, the integrity of the encryption key S is guaranteed.

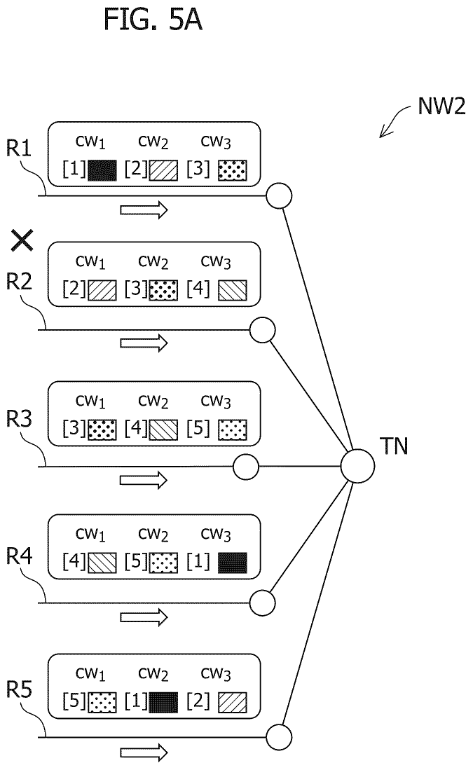

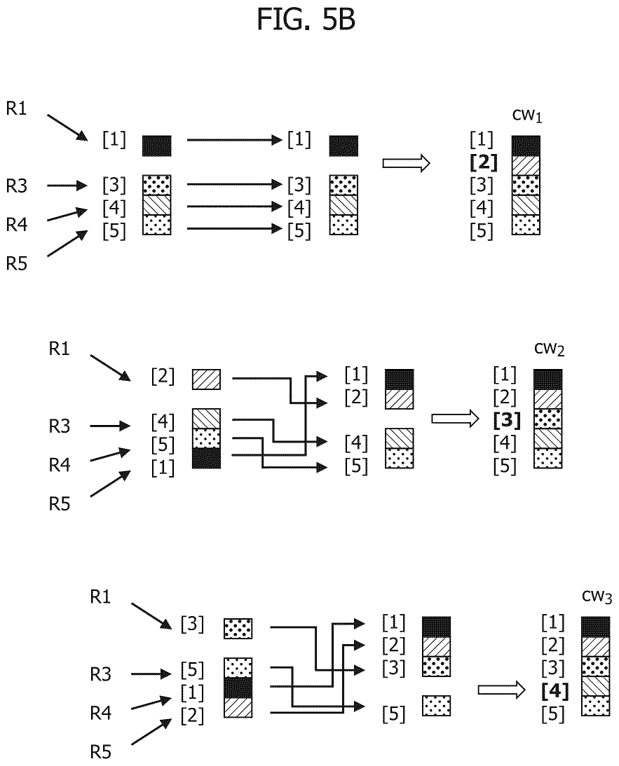

Moreover, by comparing the incorrect pattern and the codeword pattern after error correction, which are obtained through the codeword reconstruction, the receiver can determine whether the mismatch is caused by a transmission error or by tampering. If mismatches are concentrated in particular codeword segments, it can be determined that the cause is tampering.
4) In a case in which an error correction code having an erasure correction function is employed as the error correction code, robustness against failures of relay paths can be ensured. Specifically, as illustrated in FIGS. 5A and 5B, even if the relay path R2 does not function due to a failure among a plurality of relay paths and one segment (cwᵢ)ⱼ is missing for each codeword at the terminal node, it is possible to recover the original codewords cwᵢ=(cwᵢ)₁, (cwᵢ)₂, . . . , (cwᵢ)ⱼ, . . . (cwᵢ)_{nR} from a set of codeword segments transmitted through other relay paths.

As described above, it is possible to achieve distributed relay transmission of the encryption key S for which not only the secrecy, but also the integrity is guaranteed in a model in which path setting information is kept private and several relay nodes are not simultaneously compromised across all relay paths. In particular, it is possible to detect and correct sophisticated tampering of the encryption key S. Moreover, it is possible to achieve distributed relay transmission of the encryption key S even if a failure has occurred to a relay path.

A key transmission network for performing relay transmission of the encryption key can be managed and operated separately from a user service network (in other words, a network for transmitting data encrypted by using the encryption key).

Note that, it is assumed in the description so far, for simplification, that the random number data uᵢ is directly converted into the codeword cwᵢ. More generally, in a case in which the size of the random number data uᵢ is greater than the size of a codeword used, the above-described random number data uᵢ may be subdivided in order from the beginning into 2 blocks u_{i,k} (k=1 to λ) with smaller sizes, and the blocks u_{i,k} obtained through the subdivision may be converted into codewords cw_{i,k}. In this case, the codeword cw_{i,k} is divided into nR codeword segments (cw_{i,k})ⱼ (j=1 to nR) to prevent codeword replacement.

### First Embodiment

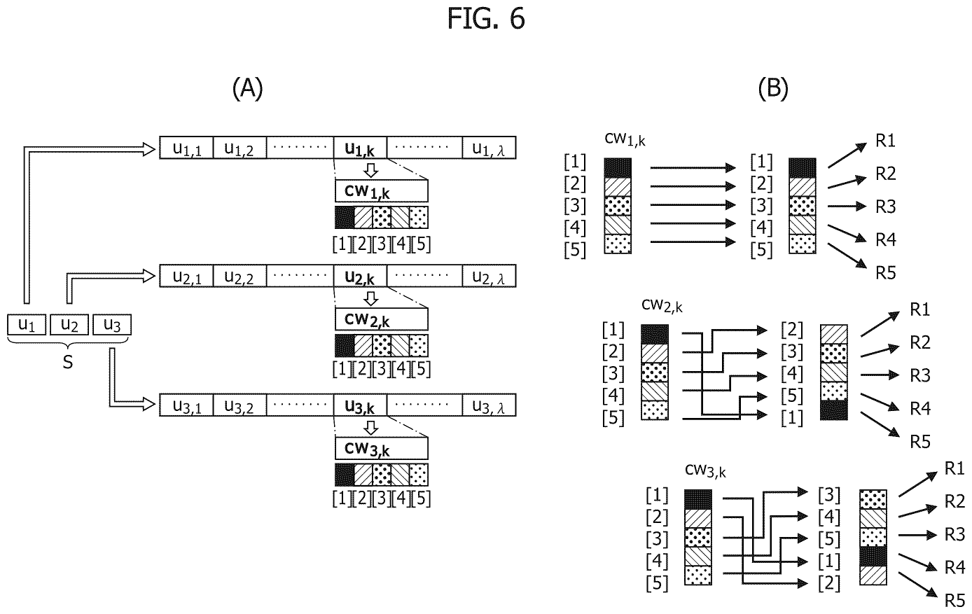

FIG. 6 illustrates a first embodiment of distributed relay transmission of the encryption key S according to the embodiment of the present invention. In the present embodiment, it is assumed that the size of the encryption key S is sufficiently greater than the size of a codeword.

The encryption key S is encrypted by using two random numbers r1 and r2 and dispersed into three pieces of random number data u₁, u₂, and u₃ (FIG. 6 (A)). That is, n=3.

Subsequently, each piece of random number data is subdivided into λ blocks. It is assumed that the size of each block is approximately equal to the size of a codeword. As an example, λ=7 can be determined in a case in which the size of the encryption key S is 7×256 bits and the size of a codeword is 256 bits. Each block is identified by a block position k. Subsequently, the error correction code is introduced for each piece of block random number data u_{i,k} to obtain the codeword cw_{i,k} (FIG. 6 (A)). The obtained codeword cw_{i,k} is divided into five codeword segments (cw_{i,k})ⱼ. Each segment is identified by an index [j] (j=1 to 5). It is assumed that there are five relay paths R1, R2, R3, R4, and R5.

As illustrated in FIG. 6 (A), a set of the three codewords cw_{1,k}, cw_{2,k}, and cw_{3,k} specified by the block position k constitute partial information of the encryption key S. More precisely, a set of the codeword segments cw_{1,k}[j], cw_{2,k}[j], and cw_{3,k}[j] having the same index [j] constitute partial information of the encryption key S. Thus, the codeword segments of the set are assigned to different paths. Specifically, the assignment to relay paths is performed after appropriately rearranging the order of the segments in accordance with the above-described rules 1 and 2.

Processing performed at the source node will be described below.
1) The encryption key S is secret-shared among the next three pieces of random number data u₁ to u₃ (FIG. 6 (A)) through the exclusive OR by using the two random numbers r1 and r2.

$${u}_{1} = S ⊕ {r}_{1} ⊕ {r}_{2} {u}_{2} = {r}_{1} {u}_{3} = {r}_{2} \qquad [ Formula 6 ]$$

$$S = {u}_{1} ⊕ {u}_{2} ⊕ {u}_{3} \qquad [ Formula 7 ]$$

holds.
2) Each piece of random number data uᵢ is subdivided in order from the beginning into λ pieces of block random number data u_{i,k} (FIG. 6 (A)). k is the block number and is an integer equal to or greater than one and equal to or less than λ.

$${u}_{1} = > {u}_{1 , 1} , {u}_{1 , 2} , … , {u}_{1 , k} , … , {u}_{1 , λ} \\ {u}_{2} = > {u}_{2 , 1} , {u}_{2 , 2} , … , {u}_{2 , k} , … , {u}_{2 , λ} \\ {u}_{3} = > {u}_{3 , 1} , {u}_{3 , 2} , … , {u}_{3 , k} , … , {u}_{3 , λ}$$

3) The error correction code is introduced for each piece of block random number data u_{i,k} to obtain the codeword cw_{i,k}. Subsequently, the codeword cw_{i,k} is divided into five segments (FIG. 6 (A)). For example, a codeword for u_{1,1} is referred to as cw_{1,1}, and the five segments of the codeword cw_{1,1} are expressed as described below.
cw_{1,1}[1]
cw_{1,1}[2]
cw_{1,1}[3]
cw_{1,1}[4]
cw_{1,1}[5]
4) As illustrated in the upper part of FIG. 6 (B), the codeword segments cw_{1,k}[1], cw_{1,k}[2], cw_{1,k}[3], cw_{1,k}[4], and cw_{1,k}[5] belonging to the codeword cw_{1,k} derived from the first random number data u₁ are assigned to the relay paths (R1, R2, R3, R4, and R5). Specifically, regardless of the block position k, cw_{1,k}[1] is assigned to the path R1, cw_{1,k}[2] is assigned to the path R2, cw_{1,k}[3] is assigned to the path R3, cw_{1,k}[4] is assigned to the path R4, and cw_{1,k}[5] is assigned to the path R5. In other words, the assignment to the relay paths is performed according to the segment index [j].
5) As illustrated in the middle part of FIG. 6 (B), the codeword segments cw_{2,k}[1], cw_{2,k}[2], cw_{2,k}[3], cw_{2,k}[4], and cw_{2,k}[5] belonging to the codeword cw_{2,k} derived from the second random number data u₂ are assigned to the relay paths (R1, R2, R3, R4, and R5). Specifically, regardless of the block position k, cw_{2,k}[1] is assigned to the path R5, cw_{2,k}[2] is assigned to the path R1, cw_{2,k}[3] is assigned to the path R2, cw_{2,k}[4] is assigned to the path R3, and cw_{2,k}[5] is assigned to the path R4. In other words, the assignment to the relay paths is performed after shifting the segment order by one.
6) As illustrated in the lower part of FIG. 6 (B), the codeword segments cw_{3,k}[1], cw_{3,k}[2], cw_{3,k}[3], cw_{3,k}[4], and cw_{3,k}[5] belonging to the codeword cw_{3,k} derived from the third random number data u₃ are assigned to the relay paths (R1, R2, R3, R4, and R5). Specifically, regardless of the block position k, cw_{3,k}[1] is assigned to the path R4, cw_{3,k}[2] is assigned to the path R5, cw_{3,k}[3] is assigned to the path R1, cw_{3,k}[4] is assigned to the path R2, and cw_{3,k}[5] is assigned to the path R3. In other words, the assignment to the relay paths is performed after shifting the segment order by two.

By assigning each segment to a relay path in accordance with the above-described rules 4), 5), and 6), it is possible to prevent partial information related to the encryption key S from being restored at a relay node on one relay path.
7) After converting information of each codeword segment into OTP encrypted data, the source node performs transmission toward each adjacent relay node on a relay path assigned in accordance with 4), 5), and 6) described above. In this case, a physical random number sequence prepared in advance for a transmission link between the source node and the relay node is used as a one-time pad. At the relay node, information of codeword segments is decrypted by using the physical random number sequence.

Processing performed at a transmission link will be described below.

At a transmission link between two adjacent nodes on a relay path, codeword segment information is encrypted and decrypted by using a physical random number sequence prepared in advance for each transmission link as a one-time pad. As the above-described processing is repeated for each transmission link, codeword segment information is relayed and transmitted to the terminal node.

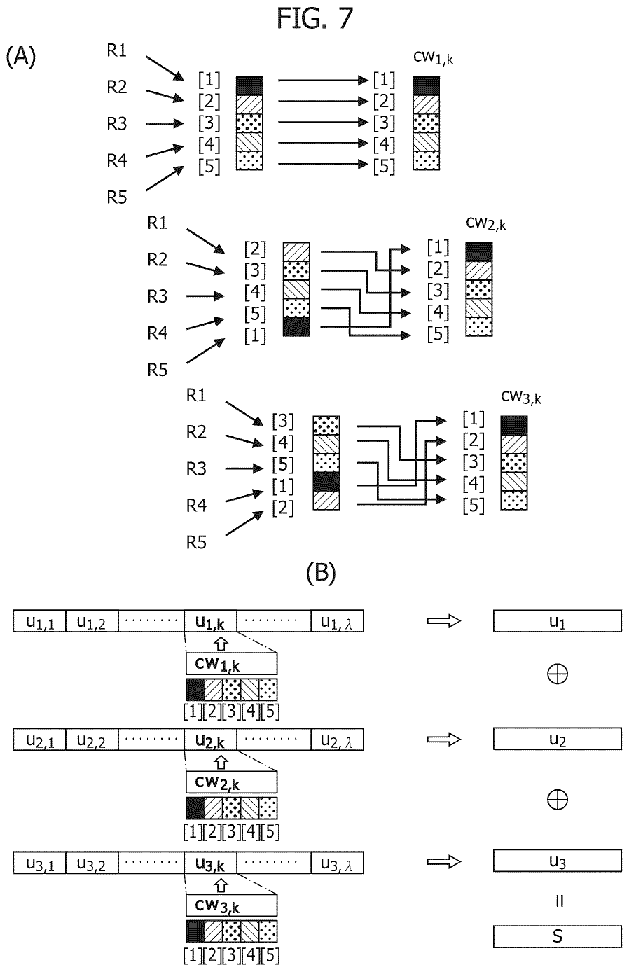

At the terminal node, a physical random number sequence prepared in advance between adjacent nodes on a relay path is used as a one-time pad to decrypt codeword segment information.
1) As illustrated in FIG. 7 (A), the codeword cw_{i,k} is restored by reconstructing five codeword segments cw_{i,k}[1], cw_{i,k}[2], cw_{i,k}[3], cw_{i,k}[4], and cw_{i,k}[5] dispersed into the five relay paths (R1, R2, R3, R4, and R5) and relayed and transmitted. Specifically, after the segment index [j] is recognized and the correct order is recovered, error correction processing is performed as necessary to restore the codeword cw_{i,k}. Then, block random number data u_{i,k} is obtained.
2) As illustrated in FIG. 7 (B), 2 pieces of block random number data u_{i,k} (k=1 to 2) are reconstructed to obtain the random number data uᵢ.
3) Similarly, as illustrated in FIG. 7 (B), the exclusive OR of three pieces of random number data uᵢ (i=1 to 3) is calculated to restore the encryption key S.

### Second Embodiment

In a second embodiment of distributed relay transmission of the encryption key S, an error correction code having an erasure correction function is employed. In this case, even if one of five codeword segments cw_{i,k}[j] (j=1 to 5) has not reached the terminal node due to a failure having occurred to any one of the five relay paths (R1, R2, R3, R4, and R5), the codeword cw_{i,k} corresponding to the block random number data u_{i,k} can be restored from the remaining four codeword segments that have reached the terminal node. As a result, even if a failure has occurred in one relay path, the correct encryption key S can be recovered at the terminal node. As an example, even in a case in which a failure has occurred to the relay path R2, all codewords can be restored as described above with reference to FIGS. 5A and 5B.

According to the embodiment described so far, it is possible to securely share a quantum cryptographic key between two locations that are farther apart than a distance over which the quantum cryptographic key can be shared by quantum key distribution.

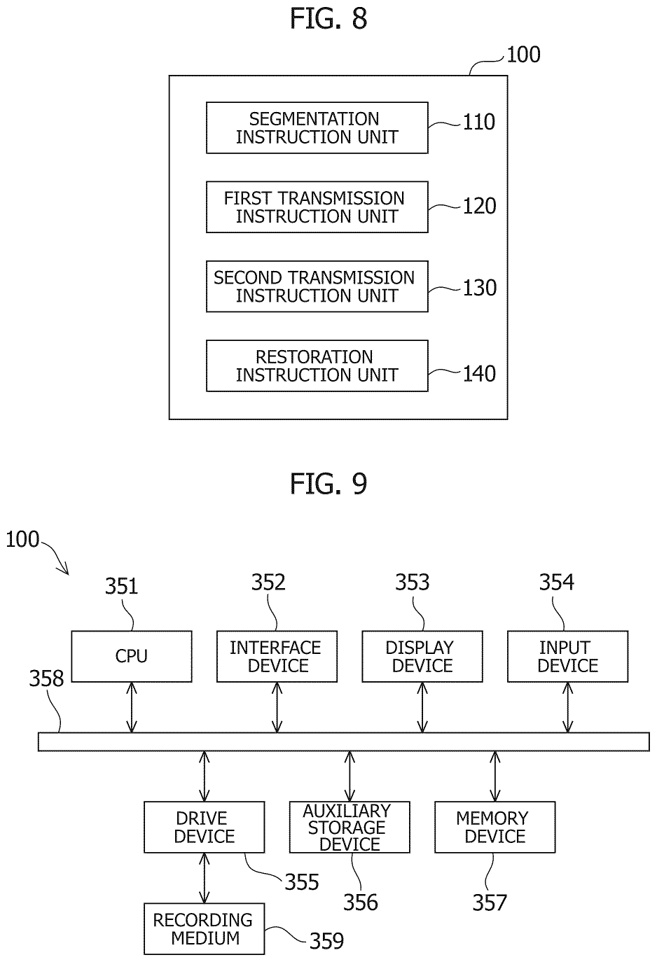

FIG. 8 illustrates a control device 100 for the communication network NW2. The control device 100 is configured to be able to perform communication with nodes in the communication network NW2 and includes a segmentation instruction unit 110, a first transmission instruction unit 120, a second transmission instruction unit 130, and a restoration instruction unit 140. A plurality of paths R1 to R5 connecting the source node SN, which is the transmission source of information (for example, the encryption key S), and the terminal node TN, which is the destination of the information, through relay nodes are set so as not to share the same relay node. The communication network NW2 and the control device 100 may be collectively referred to as a communication network system.

The segmentation instruction unit 110 instructs the source node SN to disperse the information into a plurality of pieces of random number data, to encode the random number data by an error correction code to generate codewords, and to order the codewords from the beginning and divide the codewords into a plurality of segments. The error correction code may be an error correction code having an erasure correction function.

The first transmission instruction unit 120 instructs the source node SN to transmit OTP-encrypted data of the plurality of segments through the plurality of paths. The first transmission instruction unit 120 may instruct the source node SN to transmit a plurality of segments having the same segment index through different paths.

The second transmission instruction unit 130 instructs each of the relay nodes to decrypt the OTP-encrypted data received through an upstream link on a corresponding one of the paths to acquire a corresponding one of the segments, and to transmit OTP-encrypted data of the segment toward a downstream link on the path. An upstream link of a node is a link from which data to be received by the node is transmitted. A downstream link of a node is a link to which data transmitted from the node is delivered. For example, in the communication network NW2 illustrated in FIG. 2, an upstream link of the relay node V32 is a link connecting the relay node V31 and the relay node V32. A downstream link of the relay node V32 is a link connecting the relay node V32 and the relay node V33.

The restoration instruction unit 140 instructs the terminal node TN to receive the plurality of pieces of OTP-encrypted data through upstream links on the plurality of paths, to decrypt the plurality of pieces of OTP-encrypted data to acquire the plurality of segments, to reconstruct the plurality of codewords from the plurality of segments, to perform error correction decoding on the plurality of codewords to acquire the plurality of pieces of random number data, and to restore the information from the plurality of pieces of random number data.

FIG. 9 illustrates an exemplary computer hardware configuration of the control device 100. The control device 100 includes a CPU 351, an interface device 352, a display device 353, an input device 354, a drive device 355, an auxiliary storage device 356, and a memory device 357, and these components are mutually connected through a bus 358.

A computer program that implements functions of the control device 100 is provided by a recording medium 359 such as a CD-ROM. When the recording medium 359 in which the computer program is recorded is set to the drive device 355, the computer program is installed from the recording medium 359 onto the auxiliary storage device 356 through the drive device 355. Alternatively, the installation of the computer program does not necessarily need to be performed through the recording medium 359, but may be performed through a network. The auxiliary storage device 356 stores the installed computer program and also stores necessary files, data, and the like.

When an instruction is made to activate the computer program, the memory device 357 reads and stores the computer program from the auxiliary storage device 356. The CPU 351 implements the functions of the control device 100 in accordance with the computer program stored in the memory device 357. The interface device 352 is used as an interface for connection to other computers through a network. The display device 353 displays a graphical user interface (GUI) or the like of the computer program. The input device 354 is a keyboard, a mouse, or the like.

Note that each node in the communication network has the same computer hardware configuration as the control device 100.

The above-described embodiment has not only an aspect as a device, but also an aspect as a method and an aspect as a computer program.

The following supplements are disclosed for the above-described embodiment.

### Supplement 1

A control device for a communication network including a plurality of nodes and a link connecting two of the nodes, wherein
a plurality of paths connecting a source node, which is a transmission source of information, and a terminal node, which is a destination of the information, through relay nodes, are set so as not to share the same relay node, and
the control device includes:
   a segmentation instruction unit configured to instruct the source node to disperse the information into a plurality of pieces of random number data, to encode the random number data by an error correction code to generate codewords, and to order the codewords from the beginning and divide the codewords into a plurality of segments; and
   a first transmission instruction unit configured to instruct the source node to transmit the plurality of segments through the plurality of paths.

### Supplement 2

The control device according to Supplement 1, wherein the first transmission instruction unit further instructs the source node to transmit a plurality of segments having the same segment index through different paths.

### Supplement 3

The control device according to Supplement 1 or 2, wherein the error correction code is an error correction code having an erasure correction function.

### Supplement 4

The control device according to Supplement 1 or 2, further comprising:
a second transmission instruction unit configured to instruct each of the relay nodes to receive a corresponding one of the segments through an upstream link on a corresponding one of the paths and to transmit the segment toward a downstream link on the path; and
a restoration instruction unit configured to instruct the terminal node to receive the plurality of segments through upstream links on the plurality of paths, to reconstruct the plurality of codewords from the plurality of segments, to perform error correction decoding on the plurality of codewords to acquire the plurality of pieces of random number data, and to restore the information from the plurality of pieces of random number data.

### Supplement 5

The control device according to Supplement 4, wherein
the first transmission instruction unit instructs the source node to transmit OTP-encrypted data of the plurality of segments through the plurality of paths, and
the second transmission instruction unit instructs each of the relay nodes to decrypt the OTP-encrypted data received through an upstream link on a corresponding one of the paths to acquire a corresponding one of the segments, and to transmit OTP-encrypted data of the segment toward a downstream link on the path, and the restoration instruction unit instructs the terminal node to receive the plurality of pieces of OTP-encrypted data through upstream links on the plurality of paths, to decrypt the plurality of pieces of OTP-encrypted data to acquire the plurality of segments, to reconstruct the plurality of codewords from the plurality of segments, to perform error correction decoding on the plurality of codewords to acquire the plurality of pieces of random number data, and to restore the information from the plurality of pieces of random number data.

### Supplement 6

A communication network system including the control device according to Supplement 1 or 2, the plurality of nodes, and the link connecting two of the nodes.

Although the embodiments of the present invention is described above, the present invention is not limited to the above-described embodiment but includes various modifications and changes based on the technical idea of the present invention.

### REFERENCE SYMBOL LIST

NW1, NW2 communication network
SN source node
TN terminal node
V11 to V13, V21 to V23, V31 to V33, V41 to V43, V51 to V53 relay node
R1 to R5 path
S encryption key
u₁ to u₃ random number data
cw₁ to cw₃ codeword
100 control device
110 segmentation instruction unit
120 first transmission instruction unit
130 second transmission instruction unit
140 restoration instruction unit

1. A control device for a communication network including a plurality of nodes and a link connecting two of the nodes, wherein
a plurality of paths connecting a source node, which is a transmission source of information, and a terminal node, which is a destination of the information, through relay nodes, are set so as not to share the same relay node, and
the control device includes:
a segmentation instruction unit configured to instruct the source node to disperse the information into a plurality of pieces of random number data, to encode the random number data by an error correction code to generate codewords, and to order the codewords from the beginning and divide the codewords into a plurality of segments; and
a first transmission instruction unit configured to instruct the source node to transmit the plurality of segments through the plurality of paths.

2. The control device according to claim 1, wherein the first transmission instruction unit further instructs the source node to transmit a plurality of segments having the same segment index through different ones of the paths.

3. The control device according to claim 1, wherein the error correction code is an error correction code having an erasure correction function.

4. The control device according to claim 1, further comprising:
a second transmission instruction unit configured to instruct each of the relay nodes to receive a corresponding one of the segments through an upstream link on a corresponding one of the paths and to transmit the segment toward a downstream link on the path; and
a restoration instruction unit configured to instruct the terminal node to receive the plurality of segments through upstream links on the plurality of paths, to reconstruct the plurality of codewords from the plurality of segments, to perform error correction decoding on the plurality of codewords to acquire the plurality of pieces of random number data, and to restore the information from the plurality of pieces of random number data.

5. The control device according to claim 4, wherein
the first transmission instruction unit instructs the source node to transmit OTP-encrypted data of the plurality of segments through the plurality of paths,
the second transmission instruction unit instructs each of the relay nodes to decrypt the OTP-encrypted data received through an upstream link on a corresponding one of the paths to acquire a corresponding one of the segments, and to transmit OTP-encrypted data of the segment toward a downstream link on the path, and
the restoration instruction unit instructs the terminal node to receive the plurality of pieces of OTP-encrypted data through upstream links on the plurality of paths, to decrypt the plurality of pieces of OTP-encrypted data to acquire the plurality of segments, to reconstruct the plurality of codewords from the plurality of segments, to perform error correction decoding on the plurality of codewords to acquire the plurality of pieces of random number data, and to restore the information from the plurality of pieces of random number data.

6. A communication network system including the control device according to claim 1, the plurality of nodes, and the link connecting two of the nodes.
